(19) United States
(12) Patent Application Publication
(10) Pub. No.: US 2010/0257475 A1
(43) Pub. Date: Oct. 7, 2010

(54) SYSTEM AND METHOD FOR PROVIDING MULTIPLE USER INTERFACES

(75) Inventors: ALLEN W. SMITH, San Diego, CA (US); Per O. Nielsen, Chula Vista`, CA (US); Michael J. Contour, Del Mar, CA (US)

Correspondence Address: McDermott Will & Emery LLP, 11682 El Camino Real, Suite 400, San Diego, CA, 92130, US

(73) Assignee: QUALCOMM Incorporated, San Diego, CA (US)

(21) Appl. No.: 12/419,757

(22) Filed: Apr. 7, 2009

(51) Int. Cl. G06F 3/048

(52) U.S. Cl. 715/771

(57) ABSTRACT

A system and method for providing multiple interfaces is disclosed herein. In one embodiment, a multi-interface vehicular entertainment system is disclosed, the system comprising a receiver configured to receive audiovisual content via a wireless broadcast, a first interface configured to i) render the audiovisual content, ii) receive input from a first input device, and iii) display a first graphical user interface responsive to input from the first input device, and a second interface configured to i) render the audiovisual content, ii) receive input from a second input device, and iii) display a second graphical user interface responsive to input from the second input device.

### BACKGROUND

Electronic devices such as mobile telephone handsets and other mobile devices may be configured to receive broadcasts of sports, entertainment, informational programs, or other multimedia content items. For example, audio and/or video data may be communicated using a broadband broadcast communications link to the electronic devices. There is a need to provide a person an enhanced viewing experience on such devices.

### SUMMARY

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the methods and apparatus described herein enhance user experience by providing multiple user interfaces, each adapted to a particular input device or input device type.

One aspect described herein is a multi-interface vehicular entertainment system comprising a receiver configured to receive audiovisual content via a wireless broadcast; a first interface configured to render the audiovisual content, receive input from a first input device, and display a first graphical user interface responsive to input from the first input device; and a second interface configured to render the audiovisual content, receive input from a second input device, and display a second graphical user interface responsive to input from the second input device, wherein the second graphical user interface is different from the first graphical user interface.

Another aspect described herein is a method of rendering audiovisual content, the method comprising receiving audiovisual content, receiving input from a first input device, displaying a first graphical user interface responsive to input from the first input device, rendering, based on the input from the first input device, at least a first portion of the audiovisual content, receiving input from a second input device, displaying a second graphical user interface responsive to input from the second input device, wherein the second graphical user interface is different from the first graphical user interface, and rendering, based on the input from the second input device, at least a second portion of the audiovisual content.

### BRIEF DESCRIPTION OF THE DRAWINGS

FIG. 1 is a block diagram illustrating an example system for providing broadcast programming.

FIG. 2 is a block diagram illustrating an example of a mobile device.

FIG. 3 is a block diagram illustrating a vehicular entertainment system.

FIG. 4 is a block diagram illustrating a dual interface system.

FIG. 5 is a flowchart illustrating a method of rendering audiovisual content.

### DETAILED DESCRIPTION

The apparatus and methods described herein can be embodied in a multitude of different ways, for example, as defined and covered by the claims. It should be apparent that aspects of the described apparatus and methods may be embodied in a wide variety of forms and that any specific structure, function, or both being disclosed herein is merely representative. Based on the teachings herein one skilled in the art should appreciate that the various parts, components, and steps of the apparatus and methods disclosed herein may be implemented independently of any other parts components or steps or they may be combined in a variety of manners. For example, an apparatus may be implemented independently of the described methods or a method may be practiced on apparatus varying from that described herein.

A vehicular entertainment system (VES) generally allows the driver and/or passengers of a motor vehicle to experience audio and/or video from the comfort of the vehicle. The first vehicular entertainment systems were simply AM/FM radios connected to a number of speakers. As technology progressed, more sophisticated vehicular entertainment systems developed, included those with the ability to play cassette tapes, CDs, and DVDs. Vehicular entertainment systems may also include mobile receivers configured to receive broadcasts of sports, entertainment, informational programs, or other multimedia content items. For example, audio and/or video data may be communicated using a conventional AM radio broadcast, an FM radio broadcast, a digital radio broadcast, a satellite radio broadcast, a conventional television broadcast, or a high definition television broadcast. Audiovisual data can also be received via a broadband broadcast communications link to a VES or component thereof.

With the increased functionality, the complexity of the interface experience for a user of a VES has also increased. Originally comprising a frequency tuner and perhaps one or more radio channel preset buttons, some embodiments of a VES comprise buttons, touch screens, remote controls, and other input devices. Such embodiments may also comprise a graphical user interface configured to respond to the input devices and to control the vehicular entertainment system. The input devices may, for example, via the user interfaces, change a radio station, change a video broadcast station, change a volume, change tracks of a CD or DVD, change system settings, view a program guide, set the system to record a broadcast at a later date, or interface with other vehicular systems.

Input devices suitable for use in embodiments include, but are not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, or a microphone (possibly coupled to audio processing software to, e.g., detect voice commands).

In some embodiments, a VES comprises multiple displays and multiple input devices, but only a single graphical user interface which is designed to accommodate all of the input devices. This either requires sophisticated interface design or a simplified interface capable of being manipulated by any of the input devices. This may result in a “lowest common denominator” user interface resulting in a degraded user experience. One aspect disclosed herein provides for a system including multiple user interfaces, each specifically designed to accommodate a specific input device. For example, one graphical user interface may be presented which is best navigated via touch screen and another graphical user interface may be presented which is best navigated via remote control. In another example, a user interface may be designed to accommodate a first input device and be navigable using a first input device, but unnavigable with a second input device.

Because embodiments of VES components may comprise multiple interfaces, such embodiments may afford more of a “drop-in” solution for automobile manufacturers in that each component need not be customized based on the details of the rest of the vehicular entertainment system.

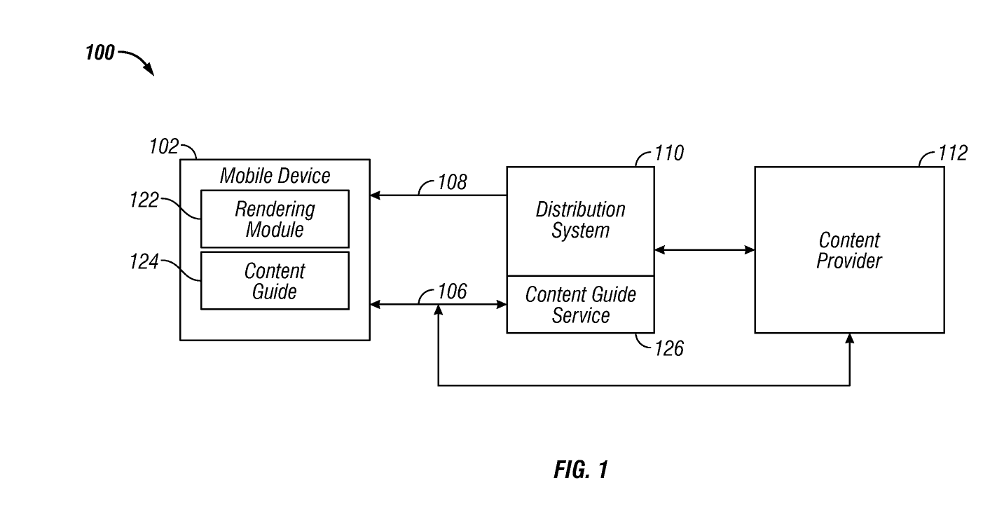

As mentioned above, some vehicular entertainment systems are configured to receive and present broadcast programming. FIG. 1 is a block diagram illustrating an example system 100 for providing broadcast programming to mobile devices 102 from one or more content providers 112 via a distribution system 110. Although the system 100 is described generally, the mobile device 102 can, for example, be a component of a vehicular entertainment system. Although one mobile device 102 is shown in FIG. 1, examples of the system 100 may be configured to use any number of mobile devices 102.

In operation, the distribution system 110 receives data representing a multimedia content item from the content provider 112. The multimedia content items are broadcast over a communication link 108. In the context of a vehicular entertainment system, the communication link 108 is generally wireless. For example, communications link 108 may conform to a mobile TV broadcasting standard such as FLO, DVB-H, DBM, or 1Seg. As used herein the term “broadcasting” generally refers to a wireless transmission of visual images, sounds, or other information. Generally such transmissions are not addressed to a particular device and any device configured according to the operating standard of the transmission may receive the transmission. It is becoming more commonplace to encode the broadcast transmission such that only devices with the appropriate code are capable of decoding the transmissions. In such a case it is not unusual to refer to such transmission as being multicast transmission. Therefore, the term “broadcasting” as utilized herein encompasses many of the concepts of multicast transmission, e.g. the goal of efficiently delivering information to a selected subset of devices simultaneously.

It is to be noted that the general architecture illustrated in FIG. 1 is but one example of a broadcast system. In another example, the content provider 112 communicates content directly to the mobile device 102 (link not shown in FIG. 1), bypassing the distribution system 110, for example utilizing the communications link 108. It is also to be recognized that any given broadcast system is not limited to a single content provider 112 or even a single communication link 108. It is also to be kept in mind that one purpose in utilizing a broadcast link for the communication link 108 is the efficient delivery of information to many, many devices 102. It is also to be noted that while the content item communication link 108 is illustrated as a forward only link it may also be a fully symmetric bi-directional link.

In the example system 100, the mobile devices 102 are also configured to communicate over a second communication link 106. In one embodiment, the second communication link 106 is a two way communication link such as a cellular based line complying with, for example, a 2, 3, or 4G standard. In the example system 100, however, the link 106 may also comprise a second link from the mobile device 102 to the distribution system 110 and/or the content provider 112. The second communication link 106 may also be a wireless network configured to communicate voice traffic and/or data traffic. The mobile devices 102 may communicate with each other over the second communication link 106. Thus, the vehicular entertainment systems may be able to communicate vehicle-to-vehicle as part of the system. Alternatively, this may enable a mobile phone to communicate with the vehicular entertainment system. In use, the communication link 106 may communicate overhead data such as content guide items, subscription requests, content requests, and other data between the distribution system 110 and the mobile devices 102.

It is to be recognized, that the communication links 106 and 108 may comprise one or more wireless links, including one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, a MediaFLO™ system, a DMB system, an orthogonal frequency division multiple access (OFDM) system, or a DVB-H system.

In addition to communicating content to the mobile device 102, the distribution system 110 may also include a program guide service 126. The program guide service 126 receives programming schedule and content related data from the content provider 112 and/or other sources and communicates data defining an electronic programming guide (EPG) 124 to the mobile device 102. The EPG 124 may include data related to the broadcast schedule of multiple broadcasts of particular content items available to be received over the communication link 108. The EPG data may include titles of content items, start and end times of particular broadcasts, category classification of programs (e.g., sports, movies, comedy, etc.), quality ratings, adult content ratings, etc. The EPG 124 may be communicated to the mobile device 102 over the communication link 108 and stored on the mobile device 102.

The mobile device 102 may also include a rendering module 122 configured to render the multimedia content items received over the content item communication link 108. The rendering module 122 may include analog and/or digital technologies. The rendering module 122 may include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage.

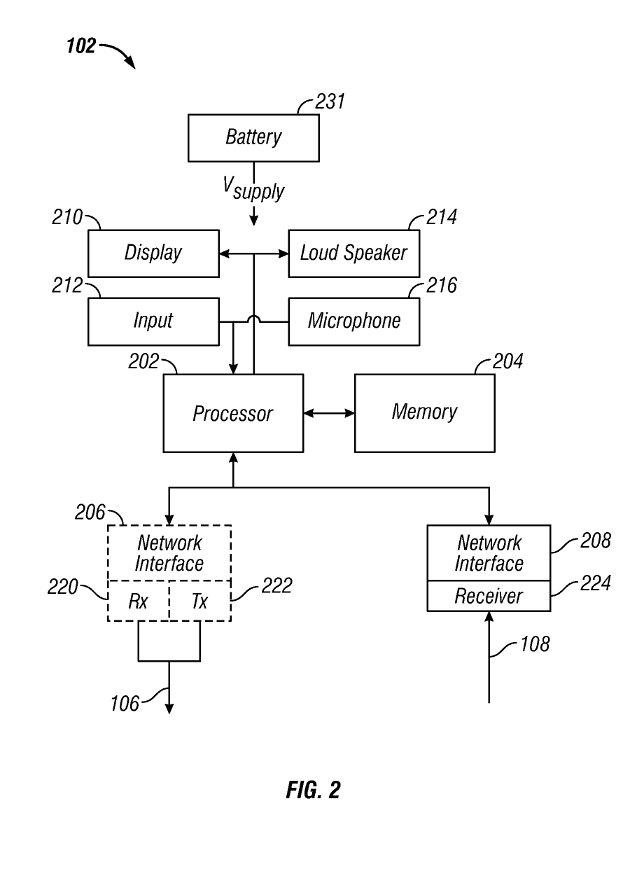

FIG. 2 is a block diagram illustrating an example of a mobile device. In particular, FIG. 2 illustrates a component of a mobile device for use with a vehicular entertainment system. A component 102 includes a processor 202 linked with a memory 204 and a network interface 208. The network interface 208 has a receiver 224 receives data from an external system via a communication link 108. The communication link 108 may operate according to any number of wireless schemes including code division multiple access (CDMA or CDMA2000), frequency division multiple access (FDMA), time division multiple access (TDMA), GSM/GPRS (General Packet Radio Service)/EDGE (enhanced data GSM environment), TETRA (Terrestrial Trunked Radio) mobile telephone, wideband code division multiple access (WCDMA), high data rate (1xEV-DO or 1xEV-DO Gold Multicast), IEEE 802.11, MediaFLO™, DMB system, orthogonal frequency division multiple access (OFDM), or DVB-H.

The component 102 may include an optional second network interface 206 for communicating via the second communication link 106 (illustrated as bi-directional). The network interface 206 may include any suitable antenna (not shown), a receiver 220, and a transmitter 222 so that the component 102 can communicate with one or more devices over the second communication link 106. Optionally, the network interface 206 may also have processing capabilities which reduce processing requirements of the processor 202.

The component 102 may also include or be operatively connected to one or more of a display system 210, a user input device 212, a loudspeaker 214 and/or a microphone 216. The display system 210 may include a screen in the front of the vehicle for viewing by the driver or front seat passenger. The display system 210 may also include one or more screens affixed with the headrest or attached to the ceiling for viewing by a rear seat passenger. The user input device 212 may be, for example a touch screen display or a remote control. The loudspeaker 214 may include the vehicular speaker system.

The component 102 may optionally include a separate battery 231 to provide power to one or more components of the device 102. Alternatively, the component may draw power from the vehicular power system, or from the battery of the vehicle.

The component 102 may be implemented in a variety of ways. Referring to FIG. 2, the component 102 is represented as a series of interrelated functional blocks that may represent apparatus and methods operating under the control of a processor configured by firmware, software or some combination thereof. This processor may, for example, be the processor 202. Further, the transmitter 222 may comprise a processor for transmitting that provides various functionalities relating to transmitting information to another device 102. The receiver 220 may further comprise a processor that provides various functionality relating to receiving information from vehicular entertainment system components.

The component 102 may be configured to receive data concurrently from one or both of the communication links 106 and 108. For example, the processor 202 may be incapable of performing the receiving and/or transmitting functions of the bidirectional network interface 206 at the same time that the broadband unidirectional interface 208 is receiving data over the communication link 108. Thus, for example, in one embodiment, reception or display of a broadcast of a program may be discontinued over the communication link 108 when a signal, e.g., a telephone call for example, is received over the communication link 106.

The component 102 may be implemented using any suitable combination of the functions and components discussed with reference to FIG. 2. In one example of the device 102, the component 102 may comprise one or more integrated circuits. Thus, such integrated circuits may comprise one or more processors that provide the functionality of the processor 202 illustrated in FIG. 2. The integrated circuit may comprise other types of components that implement some or all of the functionality of the illustrated processor components. Further, one or more processors may implement the functionality of the illustrated processor components.

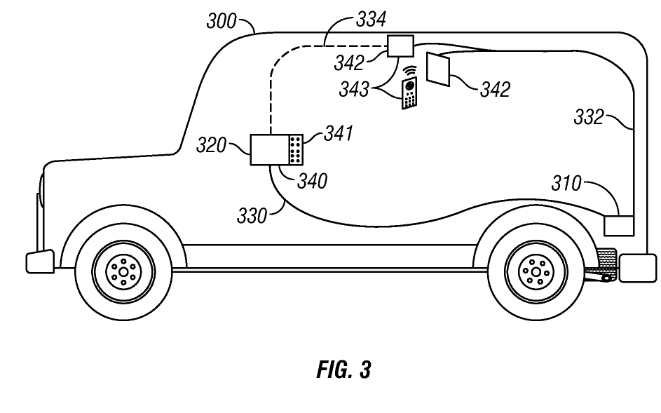

FIG. 3 is a block diagram illustrating components of vehicular entertainment system within a vehicle 300. The vehicular entertainment system (VES) comprises a controller 310 configured to, at least, transmit audiovisual content to a front interface 320 via a front interface connection 330 and to a rear interface 322 via a rear interface connection 332. The connections 330, 332 may be wired or wireless connections such as those described in detail above. The controller 310 may include a mobile device as described above with respect to FIGS. 1 and 2. Thus, the controller may be configured to receive broadcast multimedia content to provide to the displays. The controller 310 may also be connected to a computer readable medium comprising audiovisual data, such as a CD or a DVD, which is provided to the displays.

The front interface 320 comprises a front display 340 and a front input device 341. The front display 340 may be placed in a center console primarily for viewing by someone in the driver's seat or the front passenger's seat. The front input device 341 may be, for example, a touch screen, keys, or buttons. The rear interface 322 comprises a rear display 342 and a rear input device 343. The rear display 342, may include multiple screens mounted for viewing by passengers in the rear seat. The rear input device 343 may comprise, for example, a remote control and an infrared detector.

In some embodiments, the front display 340 and rear display 342 are configured to display the same video content. In such an embodiment, the front display can be driven by the connection 334. In other embodiments, the front display 340 and rear display 342 show different video content. For example, in one embodiment, the front display 340 will show received audiovisual content with a graphical user interface targeted toward the front input device 341. At the same time, the rear display 342 may show only the received audiovisual content. Alternatively, the rear display 342 may show the received audiovisual content with a graphical user interface targeted towards the rear input device 342. In some embodiments, the graphical user interface may be overlayed on top of received audiovisual content. In other embodiments, the graphical user interface may replace the audiovisual content. In still other embodiments, the graphical user interface may reformat the audiovisual content so as to take up a portion of the screen, with the graphical user interface taking up the remaining portion of the screen.

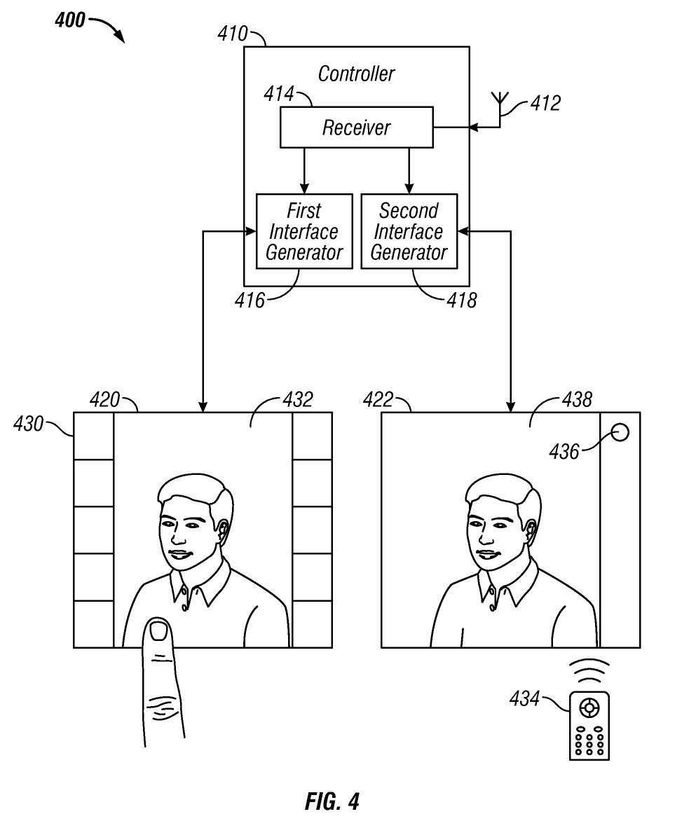

FIG. 4 is a block diagram illustrating a dual interface system. The dual interface system 400 comprises a controller 410, a first interface 420, and a second interface 422. An interface is generally a portion of a device with input functionality, output functionality, or both. An interface may contain both hardware and software components.

The first interface 420 may be distinct from the second interface 422, in that they have different hardware and/or software components. For example, in the illustrated embodiment of FIG. 4, the first interface 420 is touch screen based while the second interface 422 utilizes an infared remote control. The controller 410 is configured to transmit audiovisual content to and receive commands from the first interface 420 and the second interface 422. To accomplish this, the controller 410 comprises a receiver 414, a first interface generator 416, and a second interface generator 418.

The various illustrative logical blocks, modules, and circuits described in connection with the embodiments disclosed herein, such as the controller 410, and interface generators 416, 418, may be implemented using a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of computer readable storage medium known in the art. An exemplary storage medium is coupled to the processor such the processor can read information from, and write information to, the storage medium. In the alternative, the storage medium may be integral to the processor. The processor and the storage medium may reside in an ASIC or in any suitable commercially available chipset.

The receiver 414 may be coupled to, for example, an antenna 412 for receiving broadcast broadband multimedia content. The receiver 414 may also be coupled to a CD or DVD player. The antenna 412 may receive conventional television, AM radio, or FM radio broadcast. The antenna 412 may also receive digital radio signals, such as those associated with HD Radio, or satellite radio. The antenna 412 may also be configured to receive a MediaFLO™ broadcast. MediaFLO™ is a broadcast technology which includes real-time audio and video streams, non-realtime video and audio “clips,” and other data including stock quotes, sports scores, and weather reports.

The first interface generator 416 and second interface generator 418 are each configured to provide the audiovisual content to the first interface 420 and second interface 422 respectively. The first interface generator 416 may, for example, process the audiovisual content for improved viewing on a first display 432 of the first interface 420. For example, the first display 432 may have a certain size or resolution and the first interface generator 416 may process the audiovisual content to be compliant with this size or resolution. The first interface generator 416 is further configured to provide a first graphical user interface to the first interface 420. The graphical user interface may include a pointer, one or more windows, menus, icons, text-boxes, hyperlinks, drop-down lists, check-boxes, radio buttons, data grids, tabs, and other components known to those skilled in the art. The first graphical user interface may be specifically designed with respect to the first interface 420. In the illustrated embodiment, the first interface 420 comprises a touchscreen display 432 and a number of buttons 430 proximal to the display 432. Thus, the first graphical user interface may be designed so as to be efficiently manipulated via the touchscreen display 432 or the buttons 430. The second interface generator 418 may function similarly to provide a second graphical user interface specifically designed with respect to the second interface 422 which comprises a passive (non-touchscreen) display 438 and a remote control 434 and infrared detector 436. Thus, the second graphical user interface may be designed so as to be efficiently manipulated via the remote control 434.

In the illustrated embodiment of FIG. 4, the dual interface system comprises a single receiver 414. Both the first interface 420 and second interface 422 are configured to alter parameters of the receiver 414, such as a television broadcast station or broadband broadcast channel to which the receiver is tuned.

For example, to change a channel, a user seated in the rear passengers' set may select a channel up button on the remote control 434. Infrared signals transmitted by the remote control 434 are detected by the infrared detector 436. The second interface 422 transmits commands to the controller 410 indicating that the channel up button has been pressed. In response, the controller 410 may tune the receiver to a different channel and the second interface generator 418 may overlay an indication of the channel on the displayed video. Repeatedly pressing the channel up button may result in further channel change and the overlayed indication.

In contrast, a user seated in the driver's seat may not have access to the remote control 434, or may not be able to efficiently direct it towards the infrared detector 436. In other words, the user in the driver's seat may not have access to the second interface 422. However, the user may have access to the first interface 420. The first interface 420, as shown in FIG. 4, does not have a remote control, and thus, no channel up button. In some embodiments, one of the buttons 430 may (at times) correspond to a channel up function. In other embodiments, there are no buttons, or the buttons may not correspond to a channel up function. In this case, the user may touch the touchscreen display 432. In response, the first interface 420 transmits commands to the controller 410 indicating that the user wishes to interface. In response, the first interface generator 416 may generate and overlay a graphical user interface onto the displayed video. The graphical user interface may, for example, display buttons corresponding to channel up, channel down, volume up, volume down, power off, program guide, more options, etc. The user may then select the touch the touchscreen display 432 in the section of the screen indicating channel up to change the channel.

As both the first interface 420 and second interface 422 are configured to alter parameters of the same receiver 414, the receiver may receive conflicting commands from the different interfaces. For example, the first interface 420 may submit a command to change the channel up, but the second interface 422 may submit a command to change the channel down. As another example, the user of the first interface 420 may desire that the channel not be changed, whereas the user of the second interface 422 desires that the channel be changed. With only one receiver, the system may be unable to accommodate the conflicting commands and/or desires.

The system may be configured to give priority to one of the interfaces over the other interface. For example, in one embodiment, when the receiver 414 receives a first command from the first interface 420 to display a first channel and simultaneous, or within a predetermined time of receiving the first command, receives a second command from the second interface 422 to display a second channel, the receiver 414 responds to the first command while ignoring the second command. In another embodiment, the first interface 420 is given an option of “locking” a channel or other parameter, whereby commands from the second interface 422 to change the channel or parameter are ignored by the receiver 414. Although the above embodiments have been described with respect to interfaces with two physically separate displays, some embodiments provide two interfaces comprising only a single display but more than one interface adapted to different input devices.

In one embodiment, a dual interface system is provided with a single receiver and a single display, but two remote control interfaces. The first remote control interface is able to change volume, channel, view the program guide, access additional information about the program being viewed, and submit other commands. The second remote control interface is unable to change volume or channel, but is still able to access additional information about the program being viewed. In general, each user interface may be granted access or may be denied access to specific functionalities of the receiver.

For example, the receiver may be “locked” on a specific broadband broadcast channel by the user of the first interface 420 which is showing, in real-time, a live sporting event, such as a baseball game. As the channel is “locked,” the use of the second interface 422 is unable to submit commands to the receiver 414 to display events on another channel. However, in addition to the video of the particular sporting event, the receiver may receive and/or decode information regarding other sporting events. The user of the second interface 422 may access this information and submit commands to display the information. The user of the second interface 422, although unable to watch video of his/her preferred sporting event due to the channel being “locked,” may still be able to view metadata, such as the score or a pitch-by-pitch analysis, of his/her preferred event.

Although the illustrated embodiment of FIG. 4 comprises a single receiver 414, it also comprises a first interface 420 and a second interface 422. The first interface 420 and second interface 422 may also be configured to alter parameters of their respective interface or interface generator, such as brightness or contrast of a display, volume of a speaker, or display of additional broadcast data. In other embodiments, the first interface 420 and second interface 422 are configured to display the same video content.

With respect to the example above regarding sports-related metadata, for example, in one embodiment, both the first interface 420 and second interface 422 display the same content, meaning that the first interface 420 can also view the metadata requested by the user of the second interface 422. In another embodiment, the first interface 420 and second interface 422 display different content, meaning that although both the first interface 420 and second interface 422 receive the same video content from the receiver, only the second interface 422 also views the metadata.

With respect to the example of changing channel, as another example, in one embodiment, both the first interface 420 and second interface display the same content, meaning that the second interface 422 also sees the user interface brought up by the first interface 420 to change the channel. In another embodiment, the first interface 420 and second interface 422 display different content, meaning that a viewer of the second interface 422 only sees the channel changing, not the touch screen buttons that caused it.

In some embodiments, certain actions taken by the first interface 420 other than changing the parameters of the receiver affect the second interface 422. For example, when the user of the first interface 420 pulls up a program guide, the program guide may be configured to be navigated using the particular input device of the first interface 420. In one embodiment, the second interface 422 sees the exact same thing, but in another embodiment, the second interface 422 does not see the program guide. In yet another embodiment, the second interface 422 sees a program guide configured to be navigated using the particular input device of the second interface 422. In this way, both the user of the first interface 420 and the user of the second interface 422 can collaboratively select a program from the program guide using an interface which is navigable using their input devices.

In one embodiment, the dual interface system is implemented as part of a vehicular entertainment system. The controller may comprise, for example, a physical antenna and a processor. The processor may comprise a Qualcomm CDMA Technologies (QCT) chipset, such as from the Mobile Station Modem (MSM) chipset family. The processor may also comprise an interface command converter, such as that produced by Delphi, which processes touch screen and remote control commands from the interface into a format more easily processed by the processor. The controller may be connected to one or more interfaces via a controller-area network (CAN bus) or other vehicle bus. A vehicle bus is a specialized internal communications network that interconnects components inside a vehicle (e.g. automobile, bus, industrial or agricultural vehicle, ship, or aircraft). Special requirements for vehicle control such as assurance of message delivery, assured non-conflicting messages, assured minimum time of delivery as well as low cost, EMF noise resilience, redundant routing and other characteristics support the use of specific networking protocols. As discussed above each interface may comprise one or more input and output devices including a keyboard, buttons, keys, switches, a pointing device, a mouse, a joystick, a remote control, an infrared detector, a video camera (possibly coupled with video processing software to, e.g., detect hand gestures or facial gestures), a motion detector, a microphone (possibly coupled to audio processing software to, e.g., detect voice commands), a projector, a display, or a speaker.

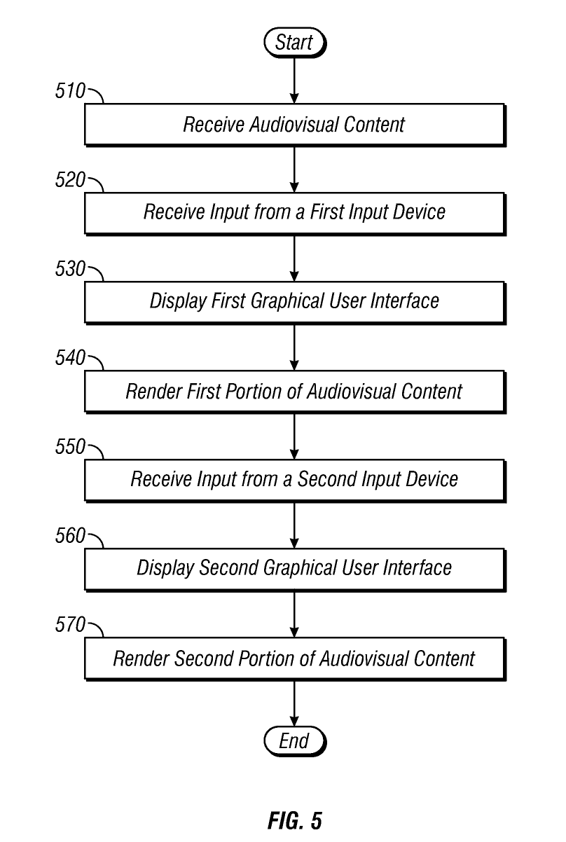

The embodiments described above, in addition to other embodiments not described, may be used in a method of rendering audiovisual content. FIG. 5 is a flowchart illustrating a method of rendering audiovisual content. The process 500 begins, in block 510, with the reception of audiovisual content. The audiovisual content may include real-time streaming video, pre-recorded video clips, or analog or digital radio broadcasts. The audiovisual content may include audio only, video only, or both audio and video components. The content may be received from a broadcast via an antenna, or may be received from a media device (e.g., a CD player, DVD player, MP3 player, etc.). The content may be received via antenna 412 of FIG. 4.

Next, in block 520, input from a first input device is received. The input can take any of a number of forms including: an infrared signal received from a remote control, a signal transmitted by an infrared detector in response to receiving an infrared signal from a remote control, a command from an interpreting module configured to generate commands from signals received from the infrared detector, a voice command issued by a user of the system, a command generated by a speech recognition module in response to a voice command, or a signal generated in response to a button being pressed. The first input device may, for example, be the touch screen 432, the remote 434, or the infrared detector 436 of FIG. 4.

Continuing to block 530, a first graphical user interface, which is responsive to input from the first input device, is displayed. As described above, the first graphical user interface may be designed such that the graphical user interface is configured to receive input from the first input device. For example, a graphical user interface adapted to a remote control having buttons corresponding to a ‘volume up’ and ‘volume down’ functionality, may not provide a pop-up screen with selections corresponding to ‘volume up’ and ‘volume down.’ In contrast, a graphical user interface adapted to a touch screen, which lacks such buttons, may provide a pop-up screen with selections for allowing the manipulation of volume. As another example, a graphical user interface adapted to a gesture recognition system may be configured to accept a limited number of inputs, e.g., only a up-down gesture and a left-right gesture, whereas a graphical user interface adapted to a voice recognition system may be configured to accept a larger number of voice commands, depending on its complexity and accuracy.

Proceeding to block 540, based on the input from the first input device, a portion of the audiovisual content is rendered. For example, the first input device may select a radio station, and the rendered audiovisual content may comprise the broadcast (music, talk, etc.) of that station. The audiovisual content may be rendered on the front display 340 or rear display 342 of FIG. 3. The audiovisual content may include audio, video, or both.

Next, in block 550, input from a second input device is received. The second input device may be a different type of input device from the first device. For example, the first input device may be a touch screen, whereas the second input device is a remote control. The second input device may be the same type of input device as the first device, with similar or different characteristics. For example, the first input device may be a remote control with 4 buttons, and the second input device may be a remote control with 20 buttons.

Continuing to block 560, a second graphical user interface is displayed. The second graphical user interface differs from the first graphical user interface. For example, the two graphical user interfaces (or at least some components thereof) may be stored in different parts of a memory or computer-readable medium. The two graphical user interfaces may be adapted to the different input devices. For example, the first graphical user interface may be adapted to a touch screen and the second graphical user interface may be adapted to a speech recognition system. A system employing such an embodiment of the process 500 may be usable by a single individual. For example, the user may select a radio station using the touch screen while parked, and then, in view of safety or legal considerations, use the less hands-on speech recognition system while driving.

Moving to block 570, another portion of audiovisual content is rendered based on the input from the second input device. With respect to the example given above, of a touch screen and speech recognition system, while parked, the user may select a radio station, which is rendered according the selection, then, while driving, the user can submit commands to change the volume or radio station using the speech recognition system, resulting in more rendering with the new parameters.

In other embodiments, the system is provided with two user interfaces using a single input device, where the user interface presented is dependent on other information. For example, the system may be able to determine if the vehicle is in a ‘park’ mode or ‘drive’ mode, based on the gear setting or speed. If the vehicle is in park, a first user interface is presented, but when the vehicle is in drive, a second interface is presented. It is possible that both the first and second interface are adapted to the same input device, e.g., the touch screen display.

While the above detailed description has shown, described, and pointed out novel features of the invention as applied to various aspects, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A multi-interface vehicular entertainment system comprising:
a receiver configured to receive audiovisual content via a wireless broadcast;
a first interface configured to:
render the audiovisual content;
receive input from a first input device; and
display a first graphical user interface responsive to input from the first input device; and
a second interface configured to:
render the audiovisual content;
receive input from a second input device; and
display a second graphical user interface responsive to input from the second input device, wherein the second graphical user interface is different from the first graphical user interface.

2. The system of claim 1, wherein the first interface comprises a first display and the second interface comprises a second display.

3. The system of claim 1, wherein the first interface comprises a display and the second interface comprises the same display.

4. The system of claim 1, wherein the first interface comprises a touch screen and the second interface comprises an infrared detector.

5. The system of claim 1, wherein the first graphical user interface is adapted to the first input device and the second graphical user interface is adapted to the second input device.

6. The system of claim 1, wherein the first graphical user interface is navigable by the first input device, the second user interface is navigable by the second interface, and either the first graphical user interface is unnavigable by the second input device or the second graphical user interface is unnavigable by the first input device.

7. The system of claim 1, wherein the first input device is configured to issue a first set of commands and the second input device is configured to issue a second set of demands, wherein the first and second set of commands are different.

8. The system of claim 1, wherein rendering the audiovisual content is based on the input received from the first or second input device.

9. The system of claim 1, further comprising a processor configured to process the audiovisual content according to a set of parameters.

10. The system of claim 9, wherein the first and second input devices are configured, via the first and second graphical user interfaces respectively, to alter the set of parameters.

11. The system of claim 1, wherein the first and second interface are configured to receive an indication of whether the vehicle is parked and to display the first graphical user interface if the vehicle is parked and the second graphical user interface if the vehicle is not parked.

12. A method of rendering audiovisual content, the method comprising:
receiving audiovisual content;
receiving input from a first input device;
displaying a first graphical user interface responsive to input from the first input device;
rendering, based on the input from the first input device, at least a first portion of the audiovisual content;
receiving input from a second input device;
displaying a second graphical user interface responsive to input from the second input device, wherein the second graphical user interface is different from the first graphical user interface; and
rendering, based on the input from the second input device, at least a second portion of the audiovisual content.

13. The method of claim 12, further comprising storing the first and second graphical user interface, wherein the first and second graphical user interface are stored in different portions of a memory.

14. The method of claim 12, wherein rendering, based on the input from the first input device, comprising at least one of: rendering with a specific volume, rendering a specific portion of a display, or rendering at a specific brightness or contrast.

15. The method of claim 12, wherein rendering, based on the input from the first input device comprises rendering a specific portion of the audiovisual content.

16. The method of claim 15, wherein rendering a specific portion of the audiovisual content comprises at least one of: rendering a specific channel, rendering a specific station, or rendering a specific track of a computer-readable medium.

17. The method of claim 12, further comprising:
determining whether the vehicle is parked; and
displaying the first graphical user interface if the vehicle is parked and the second graphical user interface if the vehicle is not parked.

18. A system for rendering audiovisual content, the system comprising:
means for receiving audiovisual content;
means for receiving a first input;
means for displaying a first graphical user interface responsive to the first input;
means for rendering, based on the first input, at least a first portion of the audiovisual content;
means for receiving a second input;
means for displaying a second graphical user interface responsive to the second input, wherein the second graphical user interface is different from the first graphical user interface; and
means for rendering, based on the second input, at least a second portion of the audiovisual content.
